(19) United States
(12) Patent Application Publication
(10) Pub. No.: US 2006/0176942 A1
(43) Pub. Date: Aug. 10, 2006

(54) On-line reconfiguration and synchronization protocol for multi-carrier DSL

(76) Inventors: Vladimir Oksman, Morganville, CA (US); Axel Clausen, Munich (DE); Umashankar Thyagarajan, Bangalore (IN)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/052,706

(22) Filed: Feb. 7, 2005

(51) Int. Cl. H04L 5/16; H04K 1/10

(52) U.S. Cl. 375/222; 375/260

(57) ABSTRACT

A communication system is disclosed, and includes a transmission system operable to transmit data to a receiver over a communications medium. The transmission system is configured to provide an indication of a change in system configuration as a synchronization flag temporarily assigned to a plurality of data sub-channels to effectuate an on-line reconfiguration (OLR) of the communication system.

### FIELD OF INVENTION

The present invention relates generally to communications systems and more particularly to systems and methods for facilitating efficient and reliable on-line reconfiguration and synchronization in such communications systems to improve their performance in changing noise conditions and service requirements.

### BACKGROUND OF THE INVENTION

Digital subscriber line (DSL) technology provides for transport of high bit-rate digital information over telephone subscriber lines. Accordingly, telephone lines can now transport data at millions of bits per second using sophisticated digital transmission techniques, wherein such techniques compensate for transmission impairments that may exist over such telephone lines. Thus DSL is widely used to provide access in both residential and business sectors.

The backbone fiber delivers high-speed digital stream carrying multiple services to the local Digital Subscriber Line Access Multiplexer (DSLAM) which distributes the service data to multiple DSL ports, equipped by DSL modems. The DSL modem delivers the service to the Customer Premises (CP) over a copper pair, often referred to as a loop, which is usually intended for a standard telephone transmission.

Telephone lines are analog, so DSL service uses various forms of modulation in order to convert a stream of DSL inputs bits into equivalent analog signals that are suitable for transport along an analog transmission line (e.g., the loop). Multi-carrier modulation uses many narrow-band sub-channels distributed over the frequency band for transmission. For example, some multi-carrier modulation standards apply discrete multi-tone (DMT) modulation technology. With DMT modulation, a communication channel, (occupying a certain frequency band in the relevant spectrum) between two modems is divided into a number of equal narrow-band sub-channels (also referred to as sub-carriers, carriers, bins, or tones) for both upstream and downstream communication. During initialization of communication between the modems, the signal-to-noise ratio (SNR) for each sub-channel is obtained. The maximum bit capacity of each sub-channel can then be determined based thereon.

Data bits to be transmitted over each sub-channel are encoded as signal points or symbols in signal constellations. Each constellation is then modulated onto a corresponding sub-channel. Generally, more bits are assigned to the sub-channels with higher SNRs, and therefore sub-channels with higher SNRs usually carry denser constellations as compared to sub-channels having lower SNRs. The total number of bits transmitted by the channel is the sum of the bits transmitted by each sub-channel. By working with a large number of narrow-band sub-channels it is easier to maximize the overall available channel capacity, thereby optimizing transmission performance.

The transmission environment of DSL is not static; rather noise conditions (as well as other conditions) and the service requirements may also vary over time. Therefore some DSL modems operate to accommodate dynamic changes in the service bit rate, and changes in noise conditions and loop conditions in a generally seamless manner, thereby avoiding an interruption in service. Some of the potential changes highlighted above may require a change in the number of data bits for modulating each sub-channel (i.e., carrier or tone) during the DSL operation.

One popular or common example of a change in the transmission environment is when noise conditions for some carriers or sub-channels degrade (due to narrow-band interference, for instance) and some of the data bits need to be moved (or re-loaded) to other carriers. For example, the sub-channel's SNR profile may be monitored by the receiver for changes associated therewith. Changes in the sub-channel's SNR profile may be caused by a variety of factors such as cross-talk noise, radio-frequency interference (RFI) and temperature changes. Bit swapping techniques can be employed to adjust for these changes by transferring bits from the noisier carriers or sub-channels to those sub-channels having a higher SNR. Such bit swapping is usually performed on a continuous basis to maintain robustness and performance quality of the communication link.

Another example of a change in transmission environment is when the data required by the service is changed, for instance, when a video terminal is turned off. In such instances the DSL can significantly reduce the transmit bit rate because the bandwidth demand has significantly decreased, and thus can reduce the transmit power and the cross-talk noise generated into other pairs. When the service is again requested, the DSL may need to quickly resume the high bit-rate operation.

DSL modems may also employ bandwidth repartitioning (sometimes referred to as dynamic rate repartitioning) across different latency paths. Generally, non-voice applications (e.g., data applications) can tolerate a higher amount of latency than voice applications since the specific sensitivity factors of human hearing do not need to be accommodated. As such, it is desirable to keep voice and non-voice applications on separate latency paths that meet their respective latency requirements. Voice applications, however, require bandwidth only when a voice call is in progress. At other times, the bandwidth allocated to a voice application is unused. As such, it may be desirable to reallocate the bandwidth assigned to a currently unused latency path so that the bandwidth may be used in other latency paths (e.g., a data path). In this sense, the available bandwidth can be dynamically repartitioned thereby providing more bandwidth to the non-voice applications over other latency paths.

In general, features such as bit swapping, rate adaptation, and bandwidth repartitioning techniques all require changes to a number of modulation parameters in the DSL modems. Collectively these changes are sometimes referred to as on-line reconfiguration (OLR). The OLR techniques require synchronization between the DSL modems at both sides of the line, so that the modulator and the demodulator in the transmitter and receiver, respectively, will change their modulation parameters starting from the same multi-carrier symbol (from the same DMT symbol in the case of DMT modulation).

Prior art methods for synchronization provide for an OLR protocol that allows a receiver to request and further initiate any of the above mentioned changes through an OLR message sent over the modem overhead or management channel. If the proposed changes are not acceptable to the transmitter (at the other side of the line), the transmitter sends a negative acknowledge message. If acceptable, the transmitter at the other side of the line sends a OLR-synchronization message (Sync-message) over the management channel that signals that the proposed reconfiguration changes will take effect at a predetermined, well-defined time after the Sync-message occurs. Unfortunately, such prior art method of synchronization does not work well for fast OLR conditions because the propagation delay introduced during the transmission of management information is much higher than the propagation delay of a DMT symbol. Consequently, use of such an OLR technique in this situation would disadvantageously require a substantial amount of data buffering at the transmitter, and negatively introduces jitter into the received signal. In addition, the special synchronization message (mentioned above as Sync-message) has to be sent from the transmitter to the receiver over a dedicated management sub-channel that is not employed for data. If the propagation delay of this marker over the management or overhead sub-channel is different from the propagation delay of the symbol over the carriers, the reconfiguration may start either before or after the time instant required.

Another prior art OLR solution suggests identifying a dedicated data sub-channel (i.e., carrier or tone) during the DSL modem initialization process or a dedicated signal point in a dense data constellation to carry signaling information with respect to a change in modulation parameters. In the first instance, by reserving a dedicated data sub-channel for signaling, the number of available carriers for data transmission is decreased, thereby potentially adversely affecting data transmission bandwidth. In addition, while the sub-channel initially selected for signaling may be appropriate, over a period of time the transmission environment may change, whereby that carrier may degrade (e.g., due to noise condition changes) and not be sufficiently robust for signaling when such signaling is needed.

The other prior art solution of using a dedicated signal point has several disadvantages. For example, the dedicated signal point is identified in the initialization process, wherein a sub-channel identified as having a high SNR (and therefore a large bit capacity) will have one of its signal points dedicated for OLR signaling. As stated above, if the noise environment changes, the dedicated signal point may no longer be reliable. Further, in the event that random user data happens to correspond to the dedicated or reserved signal point, the encoder must force this user data to pre-established values, thereby deliberately forcing a data error if additional synchronization means to mark the signal point are not provided. In addition, since the reserved signaling point cannot hold data, this prior art solution reduces the data transmission capability. Lastly, since the signaling is performed with only a single signaling point, such signaling may be unrecognized due to an impulse noise event, resulting in a situation where the transmitter will change settings without a corresponding change in the receiver (due to missing the signaling event), thereby resulting in a loss of communication therebetween.

There is a need in the art for improved signaling systems and methods that overcome the limitations and disadvantages associated with the prior art.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The present invention is directed to transmission systems and methods for data communications, wherein the transmission system is operable to perform an on-line reconfiguration (OLR) in response to changes in the data transmission environment or service bit rate requirements. In accordance with one embodiment of the present invention, an OLR is performed in a synchronized fashion between the transmitter and receiver (e.g., each DSL modems), wherein a manner in which synchronization is achieved depends on the type of OLR needed. For example, in a situation where a bit swap procedure or a bit rate decrease is to occur, an OLR may be performed rather slow (e.g., slow-OLR), wherein synchronization for the change between the transmitter and receiver is performed with a sync pattern over a dedicated sub-channel such as a management sub-channel or over multiple unused data channels that are unavailable for data transport. In contrast, in a situation such as a bit rate increase, the OLR procedure should be performed fast (e.g., fast-OLR), wherein synchronization is performed differently, via a communication of a synchronization flag over a plurality of temporarily assigned carriers. In one example, the temporarily assigned carriers employed for fast OLR are presently unused such that use of the multiple carriers for the fast OLR does not impact negatively data transmission. After synchronization for the OLR, the temporarily assigned carriers are released and may be available for data transport.

In accordance with another embodiment of the invention, the transmission system includes a management system configured to receive a bit loading table and system initialization data from a receiver, wherein the system initialization data includes the fast-OLR or slow-OLR data operable to define a manner in which synchronization of a fast OLR is to be performed. In one embodiment of the invention, the fast OLR initialization data may include one or more indications whether a synchronization flag extends over multiple symbols, and whether the synchronization requires a synchronization flag acknowledgement before execution thereof. Further, such fast OLR initialization data may include an indication whether the synchronization flag includes a synchronization flag violation pattern for improved robustness or an indication whether the synchronization flag is modulated with a different type of modulation than the data.

In accordance with another embodiment of the present invention, a method of performing an on-line reconfiguration (OLR) in a data transmission system is provided. A receiver modem determines that a reconfiguration of system operating parameters is necessary and provides an indication of such need (and the type of desired change) to a transmitter modem. In order for both the transmitter and receiver modems to adjust their operating parameters in a synchronized and seamless fashion, a synchronization marker is transmitted from the transmitter to the receiver that indicates when such reconfiguration is to occur. Depending on the type of desired change in the system configuration, a fast OLR or a slow OLR is performed, wherein in a slow OLR a synchronization pattern comprising a fixed data pattern distributed over multiple symbols is transmitted over one or more dedicated data sub-channels that are not employed for data transmission or over one or multiple unused data carriers that are presently not being employed for data transfer. In contrast, if a fast OLR is to be performed, a synchronization flag is transmitted over a plurality of temporarily assigned data carriers that are currently not in use, thereby providing for a reliable synchronization flag transmission without impacting the data transmission rate.

The following description and annexed drawings set forth in detail certain illustrative aspects and implementations of the invention. These are indicative of only a few of the various ways in which the principles of the invention may be employed.

### BRIEF DESCRIPTION OF THE DRAWINGS

FIG. 1 is a schematic diagram illustrating an exemplary multi-carrier DSL communication system with first and second DSL modems coupled with a communication channel or loop in accordance with one or more embodiments of the present invention;

FIG. 2 is a flow diagram illustrating a simplified method of performing a slow or a fast on-line reconfiguration (OLR) based on a type of desired system configuration change in accordance with the invention;

FIG. 3 is a combined flow diagram and block diagram illustrating an exemplary transmitter and receiver initialization procedure in accordance with one embodiment of the present invention;

FIG. 4 is a flow diagram illustrating a synchronization procedure in accordance with a fast OLR according to another embodiment of the present invention; and

FIG. 5 is a flow diagram illustrating a synchronization procedure in accordance with a slow OLR according to yet another embodiment of the present invention.

### DETAILED DESCRIPTION OF THE INVENTION

One or more implementations of the present invention will now be described with reference to the attached drawings, wherein like reference numerals are used to refer to like elements throughout. The invention relates to data transmission systems and methods in which synchronization between a transmitter and receiver modem is performed in order to execute an on-line reconfiguration (OLR) of transmission system operating parameters. The present invention includes a multi-carrier transmission system, wherein a synchronization flag is transmitted from a transmitter to a receiver over a plurality of temporarily assigned data carriers. By employing a plurality of temporarily assigned data carriers (also referred to as tones), transmission of the synchronization flag for a fast OLR is achieved in a reliable, robust manner without a degradation of data transmission capability (data bit rate). In one exemplary embodiment of the present invention, the transmission system distinguishes between changes in system configuration that require a fast OLR and a slow OLR, and transmits a synchronization signaling differently based thereon. For example, in a fast OLR condition, a synchronization flag is transmitted to a receiver over a plurality of temporarily assigned data carriers not presently in use, while in a slow OLR condition, a synchronization pattern is transmitted to the receiver over one or more dedicated data sub-channels not employed for data transmission, or alternatively over one or more unused data carriers that are presently not being employed for data transfer.

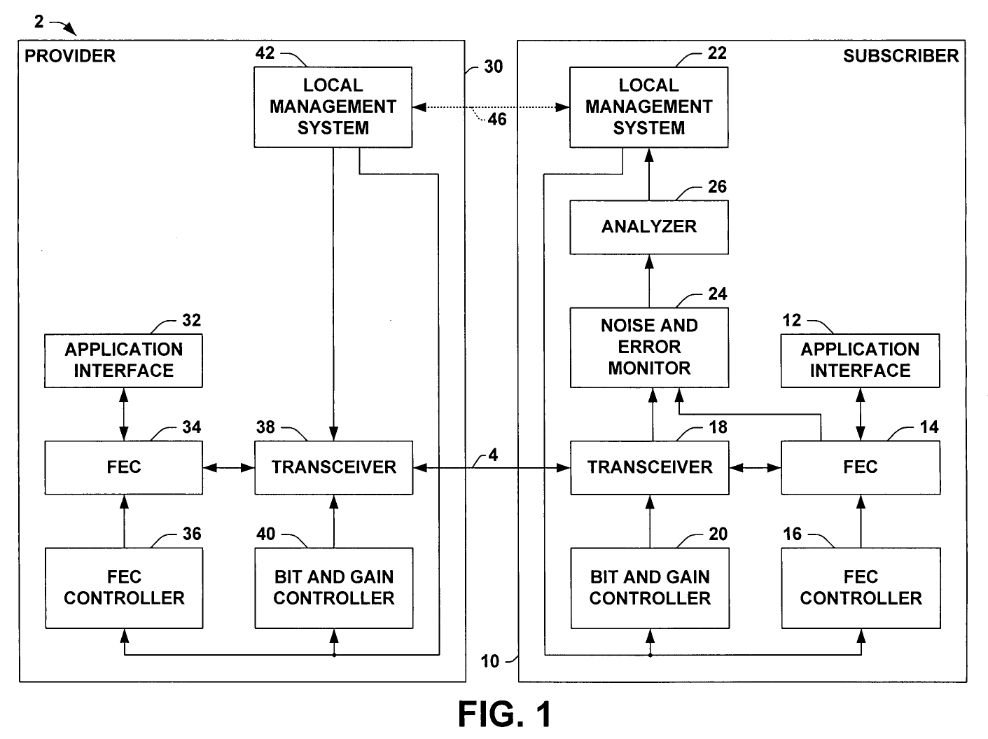

In order to appreciate various aspects of the present invention, an exemplary multi-carrier DSL system will be illustrated and described in conjunction with FIG. 1. Although the present invention will be discussed in conjunction with the transmission system of FIG. 1, it should be understood that the present invention may be employed in conjunction with any type of multi-carrier transmission system, and all such variations are contemplated as falling within the scope of the present invention.

FIG. 1 illustrates an exemplary multi-carrier DSL communication system 2 in which one or more aspects of the invention may be implemented, comprising first and second DSL modems 10 and 30, respectively, coupled with a communication loop or channel 4. The exemplary communication channel 4 is a twisted pair or copper wires in a conventional residential telephone system, although the invention may be employed in communication systems employing any type of communication channel 4 by which data can be transferred between the modems 10 and 30. The exemplary modems 10 and 30 are DSL modems having suitable circuitry for providing DSL communication service on the channel 4 generally in accordance with ANSI T1.413 (ADSL), T1.424 (VDSL) and other DSL standards, including performance of the tasks and functions described herein.

In the illustrated system 2, the first modem 10 is a subscriber modem that may be located in a residential home, and the second modem 30 is located at a DSL service provider. Data is transferred in both directions along the channel 4, wherein the subscriber modem 10 transmits data to be received by the provider modem 30 and the provider modem 30 transmits data to be received by the subscriber modem 10. In this regard, the exemplary communication system 2 is symmetrical, although the various aspects of the invention may be carried out in other systems in which data is transferred in a single direction only. In order to appreciate the various aspects of the invention, the exemplary system 2 and the various methods of the invention are hereinafter described with respect to data being transferred in a first direction from the provider modem 30 to the subscriber modem 10. Accordingly, in the following discussion, the first modem 10 (specifically, a transceiver 18 thereof) may be referred to as a “receiver” and the second modem 30 (specifically, a transceiver 38 thereof) may be referred to as a “transmitter” for purposes of describing the various aspects of the invention, with the first (receiver) modem 10 monitoring and analyzing continuous and impulse noise and proposing transmission parameter and/or noise protection parameter changes to the second (transmitter) modem 30, which then institutes the changes. However, it will be appreciated that both modems 10 and 30 are capable of transmitting and receiving data in the illustrated implementation, wherein the modems 10 and 30 may both be configured to monitor noise with respect to data received thereby and to selectively propose and to institute parameter changes based on changes in the data transmission environment in a cooperative manner with the other modem.

In the exemplary system 2, the first modem 10 is adapted to monitor noise and/or other environmental or performance indicia with respect to data received on the communication channel 4 from the second modem 30 during communication service. The first modem 10 analyzes the monitored noise and/or other indicia and selectively proposes appropriate parameter changes to the second modem 30 in response thereto. The modems 10 and 30 are adapted to cooperatively adjust their noise immunity, noise margin or transmission bit rate, etc., for transferring data from the modem 30 to the modem 10 according to the observed noise or other indicia without interrupting the communication service.

The exemplary first modem 10 comprises a transceiver 18 that is operably coupled to the channel 4 and operates to support communication (e.g., DSL) service with the second modem 30. With respect to received data from the second modem 30, the transceiver 18 operates to receive such data from the channel 4. The first modem 10 also comprises an application interface 12 to a host system, such as a service subscriber's home computer (not shown), wherein the second modem 30 also comprises an application interface 32 with a network node (not shown). The forward error correction (FEC) system 14 of the first modem 10 comprises an FEC decoder and a de-interleaver operating in conjunction with an FEC controller 16, wherein the FEC system 34 of the second modem 30 includes an FEC encoder and an interleaver (IL) with a corresponding FEC controller 36, where the FEC system 34 provides redundancy bytes to outgoing data when transmitting to the first modem 10. The FEC system 14 of the receiving first modem 10, in turn, uses received redundancy bytes to correct errors in incoming data (when receiving data from the second modem 30). In a bidirectional setting, the FEC system 14 of the first modem 10 further provides FEC encoding and interleaving of outgoing data (when transmitting data to the second modem 30) and the FEC system 34 of the second modem 30 provides de-interleaving and FEC decoding of incoming data (when receiving data from the second modem 30), wherein the exemplary FEC systems 14 and 34 each comprises suitable logic circuits for controlling the FEC functions described herein, as well as memory for buffering data to be interleaved/de-interleaved.

For the transmission direction from the provider to the subscriber, the transceiver 18 of the first modem 10 provides demodulation of the incoming signal from the second modem 30, and includes suitable circuits for interfacing with the communication channel 4 for receipt of incoming data. In the second modem 30, the transceiver 38 provides for tone ordering or bit distribution, wherein it determines how many outgoing data bits to be transmitted over each sub-channel of the multi-channel or multi-carrier system (i.e., to be encoded as signal points in signal constellations of each sub-channel) using bit distribution parameters provided by a bit distribution controller 40 that includes, for example, a bit loading table. The transceiver 38 of the second modem 30 also modulates the outgoing channel or carrier constellations (in the presented example using inverse discrete Fourier transform (IDFT)) and provides the modulated signals to the channel 4 according to channel gain scale settings from the controller 40 (e.g., based on parameters specified in the bit loading table). For incoming data received from the second modem 30, the transceiver 18 of the first modem 10 demodulates the received signals into individual carrier constellations (e.g., by discrete Fourier transform or DFT techniques in the present example), and decodes the received constellations according to the parameters from a corresponding bit distribution controller 20 that includes the bit loading table.

The first modem 10 also includes a local management system 22 that provides the complete set of modem parameters to support signal transmission, including the FEC parameters to the FEC controller 16 for the number of redundancy bytes in the received data and the amount or level of de-interleaving thereof, and also provides parameters to the controller 20, including sub-channel or carrier bit allocations, gain settings, etc. for decoding and demodulation of the incoming data received from the channel 4. As will be described in greater detail infra, subsequent changes in such modem configuration parameters may be communicated between the two modems via the management channel 46 and facilitated by specific synchronization flags or synchronization patterns based on the type of change desired over a plurality of carriers associated with the channel or loop 4. The FEC system 14 then performs de-interleaving and error correction according to parameters from the FEC controller 16, and provides the resulting incoming data to the application interface 12.

The second modem 30 implements similar functionality with respect to normal DSL communication service, and comprises a transceiver 38 coupled with the channel 4, a bit distribution and gain setting system 40 that controls the modulation (demodulation) and encoding (decoding) of data in the transceiver 38. The second modem 30 further comprises an application interface 32 for interfacing to a host system (not shown), as well as an FEC system 34 and a corresponding FEC controller 36 for providing data interleaving and forward error correction functions similar to those described above with respect to the first modem 10. The second modem 30 also includes a local management system 42, providing control parameters and settings to the FEC controller 36 and to the bit distribution and gain setting controller 40.

The local management systems 22 and 42 of the first and second modems 10 and 30, respectively, exchange control information and messages with one another via a local management channel 46, using any suitable communication or data exchange protocol.

In the illustrated system 2, the local management systems 22 and 42 exchange settings and information via the management channel 46 during system initialization for establishing initial sub-channel or carrier bit capacities and gain settings based on initial measurements of the continuous noise levels of the various channels. For instance, during initialization, the signal-to-noise ratio (SNR) for each sub-channel or carrier is obtained, and the maximum bit capacity of each carrier is determined by one of the modems 10, 30 (usually the receiving modem). This information is sent to the other modem, such that upon initiating DSL service, the modems are using the same parameters. Likewise, FEC parameters and codeword size are initially set by one of the modems, according to initial noise measurements or according to some other criteria (e.g., max noise protection), with the settings being replicated to the other modem via the management channel 46, as will be described in greater detail infra.

In accordance with the present invention, the exemplary first modem 10 also comprises a noise and error monitor system 24 and an analyzer 26, wherein the monitor system 24 monitors noise level and data transfer errors occurring on the communication channel 4 for incoming data received from the second modem 30 via the SNR information from the transceiver 18 and error information from the FEC system 14 during DSL service, and the analyzer 26 determines the causes of the incoming data transfer errors. Either or both of the analyzer 26 and the monitor system 24, and/or any of the other components of the first modem 10 illustrated in FIG. 1 may be fabricated together with the transceiver 18 as a single integrated circuit. It is noted that the exemplary second modem 30 also comprises noise monitoring and analyzing components (not shown) for monitoring and analyzing noise and data transfer errors for data transferred from the first modem 10 to the second modem 30, wherein the various features of the invention are provided for data being transferred in both directions along the channel 4 in the exemplary system 2.

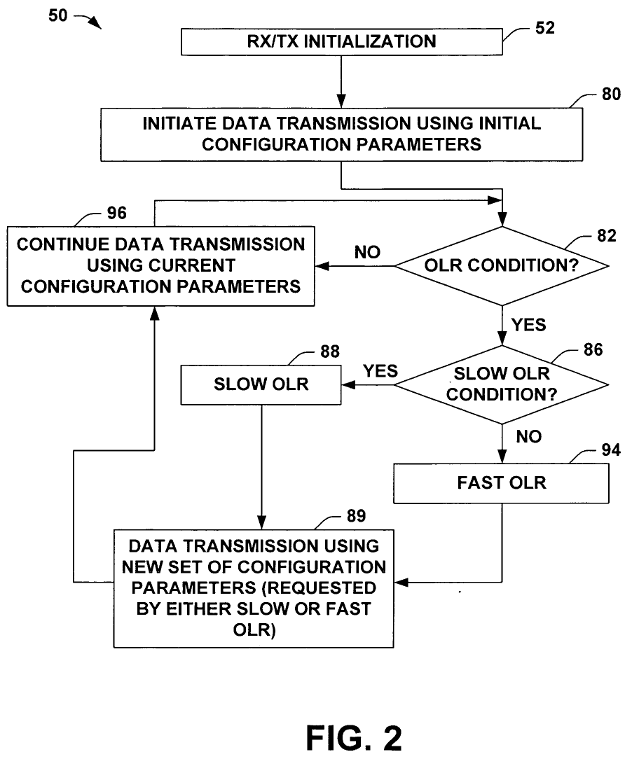

As illustrated and described further below with respect to FIGS. 2-5, upon system initialization and subsequent assessment of the data transmission environment changes, the analyzer 26 in the receiver selectively recommends system parameter changes to the local management system 22 (e.g., changes to FEC parameters such as codeword size or number of redundancy bytes in one example or bit distribution changes in another example). As will be described in greater detail infra, the subscriber modem 10 and provider modem 30 cooperatively interact together to coordinate synchronized implementation of such system configuration changes during the communication service (on-line reconfiguration (OLR)) in the system 2 without interrupting the communication service. More particularly, the manner in which the modems 10, 30 interact with one another will vary depending on a type of OLR to be executed, that is, whether the OLR is a fast OLR or a slow OLR. Upon communication thereof, the second modem 30 provides a synchronization marker to co-ordinate changes in the settings of both modems without service interruption on the channel 4. As will be further appreciated below, for fast OLR, the marker comprises a flag distributed over a plurality of temporarily assigned data carriers in one or few consequent symbols or several symbols of pre-defined order for prompt, robust signaling, while for slow OLR, the marker comprises a periodic pattern extending over multiple symbols that is transmitted to the receiver modem over one or more dedicated sub-channels that are not employed for data transmission, or alternatively over one or more unused data carriers that are currently not being used for data transmission.

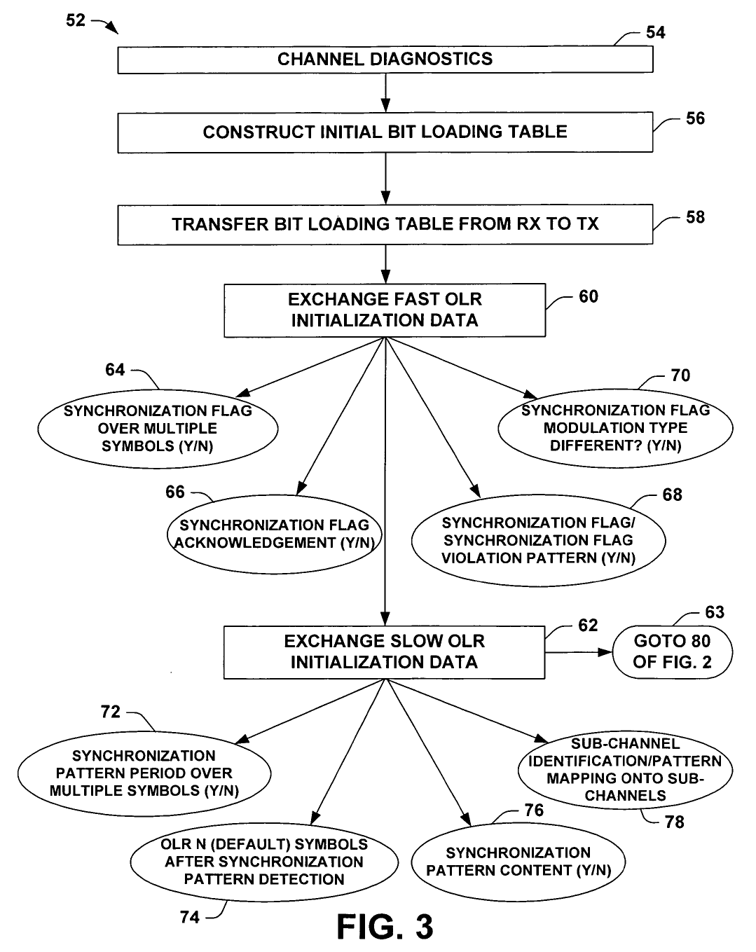

Turning now to FIG. 2, operations and/or a method 50 of performing synchronization for an OLR in a system such as the system 2 of FIG. 1 is provided. Upon system initialization at 52, a diagnostic procedure may proceed as discussed supra, wherein initial system configuration parameters are determined at the receiver and communicated back to the transmitter. For example, referring to FIG. 3, an exemplary initialization process 52 is illustrated. Channel diagnostics are performed at 54, wherein, for example, impulse and/or continuous noise measurements are taken over the many data carriers of the channel or loop 4, and an initial bit loading table is constructed at 56. In one embodiment, the constructed bit loading table and the initial system configuration is communicated or otherwise transferred to the transmitter modem (e.g., modem 30) over the management channel 46 at 58.

Still referring to FIG. 3, fast and slow OLR initialization data is also transmitted over the management channel 46 at 60 and 62, respectively. As will be further appreciated below, the fast OLR initialization data may include the data indicating that when a synchronization flag is transmitted, such a flag will reside within a single symbol or extend over a specific number of symbols (multiple symbols) 64. Alternatively, or in addition, the initialization data 60 may include data regarding whether transmission of a synchronization flag acknowledgement 66 is required to be sent back to the transmitter before the fast OLR may proceed. Further, such OLR data 60 may include an indication that the synchronization flag further comprises a synchronization flag violation pattern 68 so that both the synchronization flag and violation pattern must be detected to conclude an OLR is to occur (thereby minimizing chances of a false synchronization flag detection). Lastly, the fast OLR initialization data 60 may include an indication whether the synchronization flag will be processed according to a modulation technique that is the same or that differs from the modulation technique employed for the data at 70.

Slow OLR initialization data 62 will also be communicated over the management channel 46 during initialization at 52. For example, the content of the slow OLR synchronization pattern may be communicated, such as whether the synchronization pattern will comprise a fixed data pattern residing within a single symbol or extending over multiple symbols at 72, specify the default time period in which the OLR will take place at 74 relative to the time marker of the synchronization pattern, synchronization pattern content such as whether the synchronization pattern will comprise a predefined violation, or include two alternating codewords with a large mutual Hamming distance, etc., at 76. In addition, the initialization data includes information regarding over which sub-channels the pattern will be transmitted, and information as to how the pattern is mapped onto the sub-channels at 78. As illustrated in FIG. 3, after the exchange of initialization data, the method 50 returns to act 80 of FIG. 2 at 63.

Returning to FIG. 2, data transmission proceeds at 80 according to the initial configuration parameters provided at the initialization at 52. During such data transmission, the receiver modem (e.g., the modem 10 of FIG. 1) continues to perform monitoring (e.g., impulse and/or continuous noise, etc.) and at 82 a query is made whether a data transmission environment change or change in service has occurred that necessitates a reconfiguration of system parameters. If no changes are warranted (NO at 82), then data transmission continues at 96 according to the current configuration parameters. If, however, an OLR is warranted (YES at 82) a query is made at 86 whether the necessary change can be executed via a slow OLR (i.e., whether the change is a slow OLR condition). For example, if a bit swap (a change in the bit loading that does not alter the bit rate) is desired (e.g., due to a change in noise conditions) or if a bit loading change aimed to decrease the bit rate is requested, the answer to the query at 86 is YES, and a slow OLR is again performed at 88. Data transmission in accordance with the newly-set configuration parameters requested by the slow OLR proceeds at 89. The method 50 then returns to 96, wherein data transmission continues using the modified configuration parameters required by the slow OLR, and further OLR condition monitoring is performed at 82. If, however, a slow OLR condition does not exist (NO at 86), for example, as a bit loading change aimed to increase the bit rate is solicited in response to an incoming additional broadband service, then a fast OLR is performed at 94. Data transmission in accordance with the newly-set configuration parameters requested by the fast OLR then proceeds at 89, and the method 50 returns to 96, wherein data transmission continues using the configuration parameters required by the fast OLR, and further OLR condition monitoring is performed at 82.

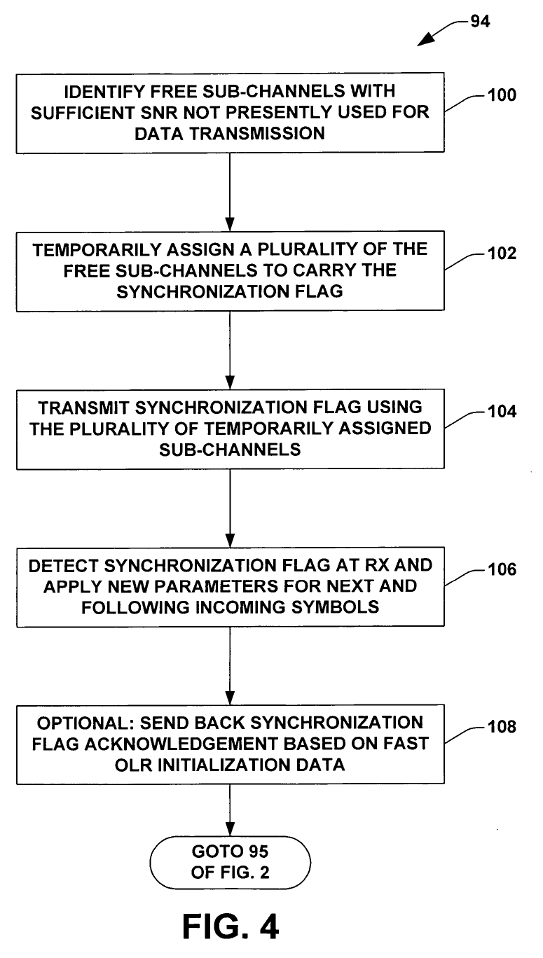

The fast OLR procedure 94 of FIG. 2 is illustrated in greater detail in FIG. 4 in accordance with one embodiment of the present invention. Note that in the present example, the fast OLR is performed in conjunction with a bit rate increase reconfiguration, however, other reconfigurations may be assigned using a fast OLR procedure, and such alternatives are contemplated as falling within the scope of the present invention.

The fast OLR procedure 94 starts at 100 with the identification of free sub-channels that are presently not being used for data transmission. Such sub-channels are clearly available in the case of a bit rate increase reconfiguration because without free sub-channels being available, no bit rate increase is possible. Which of the sub-channels are available is known to the system 2 of FIG. 1 based on the present bit loading table configuration, and a plurality of such sub-channels are temporarily assigned at 102 to carry the synchronization flag. In order to maximize reliability, the synchronization flag is transmitted over several temporarily assigned data sub-channels (the more sub-channels involved increases the reliability, but complicates detection of the synchronization flag at the receive side and limits the data transmission capabilities).

Preferably the temporarily assigned data sub-channels are selectively temporarily assigned at 102. For example, although the present bit loading table configuration will indicate many sub-channels not presently in use for transmitting data, some of these “available” sub-channels are not being used for data transmission due to quality reasons, for example, they exhibit a low signal-to-noise ratio (SNR) in the present noise environment. Consequently, it is preferred that a selection of the plurality of sub-channels for temporarily carrying the synchronization flag be selected to provide reliable transmission under the current noise conditions. In one example, if previously the system was placed into a low bit rate configuration (e.g., a low power mode due to slow traffic) using a slow OLR (to be discussed in greater detail infra), then some sub-channels having an acceptable SNR were released from data transport (to reduce the bit rate) and these carriers are known to be reliable for synchronization flag transmission and are known to the system 2. In another case, when all the sub-channels with high SNR are used for data transport, a longer synchronization flag and/or repeatable synchronization flag constituting a pattern may be used to utilize those sub-channels have an SNR that is not sufficient for data transport.

The synchronization flag is then transmitted from the transmitter modem 30 to the receiver modem 10 over the loop 4 using the plurality of temporarily assigned sub-channels at 104. Various differing synchronization flag content may be employed and are contemplated as falling within the scope of the present invention. In one example, the fast OLR synchronization flag is a short, fixed pattern of one symbol in length, or even shorter than one symbol. In another example, the synchronization flag may be several symbols long, and be implemented as a longer pattern running over all symbols or a periodically repeating pattern over each symbol. Use of longer patterns provides better noise protection, especially for impulse noise, since a properly constructed pattern (with high redundancy) could be easily recognized even if a part of the pattern is erased by the impulse noise. Use of a longer pattern also allows mitigation of the random component of the noise, thus even sub-channels with lower SNR could be used for the synchronization flag, as mentioned above. This allows even more freedom for sub-channel selection, but requires a more complex receiver and involves additional signal buffering and jitter.

If the synchronization flag is sent over sub-channels that carry data, additional steps may be taken to add to the synchronization flag content to avoid synchronization error (when the transmit data occasionally looks like the synchronization flag) and such options are contemplated by the present invention. For example, in order to minimize the chance that data on the sub-channels that looks similar to the synchronization flag creates a false synchronization flag detection, a pre-defined synchronization violation pattern (e.g., pre-defined in the fast OLR initialization data) may be introduced into the symbol(s) that carry the synchronization flag. In that manner, a synchronization flag will be recognized only when both the synchronization flag and the synchronization violation pattern are both detected, thereby reducing the possibility of a false synchronization flag detection. Alternatively, or in addition, a special modulation type may be employed for the synchronization flag that is different from the one used for data. For example, if data is modulated using QAM, a special constellation diagram or mapping may be used for the synchronization flag. In order to further improve the reliability of the synchronization flag transmission, it is desirable that the synchronization flag have high redundancy and a large distance (Hamming and/or Euclidean) from the data.

Still referring to FIG. 4, at 106 the receiver modem (e.g., the modem 10 of FIG. 1) receives and detects the synchronization flag and applies new parameters (e.g., based on the next entry in the bit loading table) at a specified time (e.g., as dictated in information shared during initialization) that matches the change in the transmitter (e.g., the modem 30). In one example, the change is performed in the next symbol to effectuate a fast OLR. Alternatively, in order to prevent a possible situation where the synchronization flag is transmitted, but not detected at the receiver, the transmitter delays reconfiguration until the receiver sends back a synchronization flag acknowledgement (e.g., based upon the fast OLR initialization data) over a sub-channel at 108 at which point the reconfiguration occurs in a synchronized fashion between the transmitter modem 30 and the receiver modem 10, respectively.

The temporary assignment of a plurality of sub-channels for use in transmitting the synchronization flag has advantages over prior art OLR techniques. For example, unlike the prior art solution that uses a pre-defined, dedicated sub-channel (a signal point) to carry synchronization signaling information, the present invention provides a fast OLR having reliable signaling by temporarily assigning a plurality of sub-channels for carrying the synchronization flag. After signaling thereof, the temporarily assigned data sub-channels are released from the synchronization flag and may be employed for data transport, if desired. Since the sub-channels used were free tones, the signaling method of the present invention does not negatively impact data transmission.

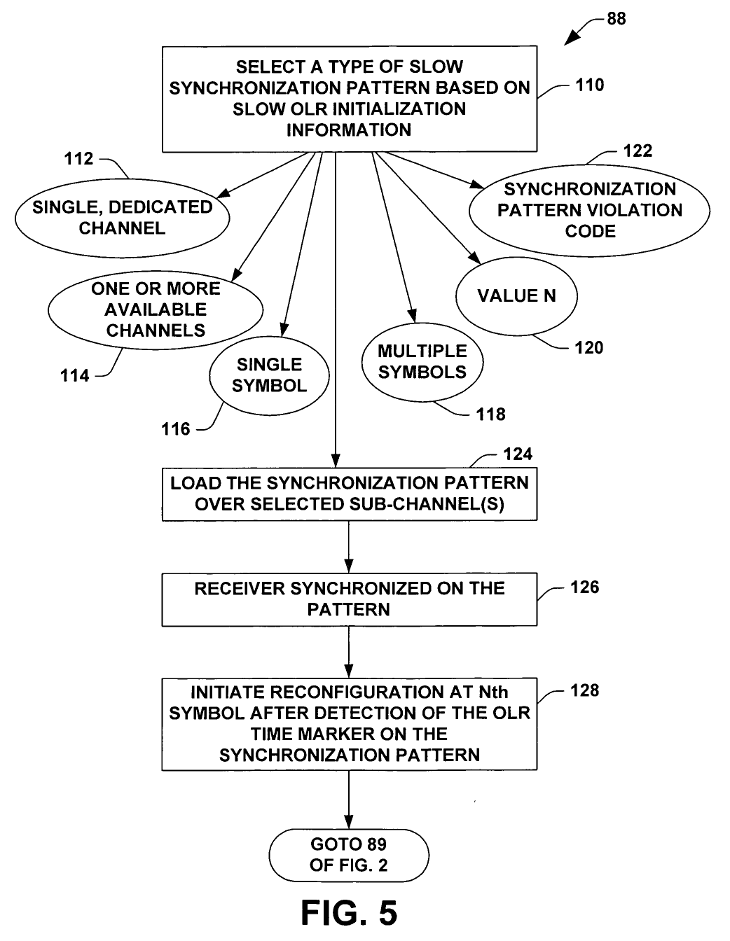

Referring back to FIG. 2, some types of system reconfiguration, such as a bit-swap or a bit rate reduction, do not necessarily need a fast OLR, and in such instances a slow OLR procedure 88 may suffice. In accordance with one embodiment of the invention, a slow OLR procedure 88 is illustrated in FIG. 5. In one example, the type of slow synchronization pattern is selected based on the slow OLR synchronization data at 110, such as whether one or more dedicated sub-channels are to be employed 112, or whether one or more available sub-channels are to be used 114. In addition, the selection of the synchronization pattern will include whether such pattern resides in a single symbol 116, or in multiple symbols 118, the value N 120 (as described earlier), and the synchronization pattern violation if employed at 122. The synchronization pattern is then loaded over the selected sub-channel or sub-channels at 124. In one embodiment, the synchronization pattern is loaded onto one or more dedicated sub-channels; alternatively, the synchronization pattern is loaded over one or more available sub-channels. In one embodiment, sub-channels may be available that are not being used for data transport because the SNR associated therewith is too low, however, such tones may be employed for slow synchronization signaling because the synchronization pattern is periodical and thus highly reliable, and encoding with additional gain may be applied.

For example, a synchronization pattern having high reliability is preferably employed for slow OLR, such as a periodic pattern spread over many symbols. Since this is a high reliability mechanism, the SNR of carrier(s) used for the slow OLR synchronization pattern can be significantly below the SNR used for data. In one embodiment, the synchronization pattern content comprises a fixed data pattern that contains at least two alternating codewords with large mutual Hamming distance, wherein the codewords are spread over multiple symbols. In one further example, the codewords are mapped such that the transition between the codewords falls between consequent symbols.

The receiver is then synchronized on the pattern at 126 and then, based upon the slow OLR initialization information 120, the reconfiguration occurs starting at the N-th symbol after the marked time on the synchronization pattern at 128, wherein N is an integer. The default value of N may be provided in the slow OLR initialization information 62, although a value which is different from the default may be communicated prior to the OLR over the management channel 46 together with the time marker on the synchronization pattern from which N symbols should be counted. This marker is usually the start of the next period of the pattern, but it may be also a special indication such as a predefined violation in periodicity of the pattern and similar. Returning to FIG. 2, data transmission using the new set of configuration parameters commences at 89, and the method 50 continues.

Although the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A communication system, comprising:
a transmission system operable to transmit data to a receiver over a communications medium, and configured to provide an indication of a change in system configuration as a synchronization flag temporarily assigned to a plurality of data sub-channels.

2. The communication system of claim 1, wherein the change in system configuration comprises a change in data bit rate, bit loading, a forward error correction (FEC) parameter change, or a change in transmit power.

3. The communication system of claim 1, wherein the communications medium comprises a digital subscriber line (DSL) loop, and wherein the transmission system and the receiver comprise a DSL modem.

4. The communication system of claim 1, wherein the transmission system further comprises a bit loading table configured to specify a bit loading for a plurality of sub-channels in a present system configuration and a bit loading for the plurality of sub-channels in a next system configuration upon a change in system configuration.

5. The communication system of claim 1, wherein the transmission system is further configured to distinguish between a fast system configuration change and a slow system configuration change based on a signal representing a system configuration change request from the receiver or a service change command, and wherein upon determination of a slow system configuration change the indication further comprises a synchronization pattern that is spread over a plurality of transmitted symbols and is assigned to one or more dedicated data sub-channels, not employed for data transmission or is assigned to one or more available data sub-channels currently unused for data transmission.

6. The communication system of claim 5, wherein the synchronization pattern comprises at least two alternating codewords having a large mutual Hamming distance associated therewith.

7. The communication system of claim 6, wherein the at least two alternating codewords are mapped such that a transition between the two codewords always resides between two consequent transmitted (DMT) symbols.

8. The communication system of claim 5, further comprising a management system adapted to define when the change in system configuration is to occur based on a predetermined number of transmitted (DMT) symbols after a marker associated with the synchronization pattern, thereby facilitating a synchronization in the change in system configuration between the transmission system and the receiver operably coupled thereto.

9. The communication system of claim 8, wherein the one or more dedicated data sub-channels comprise a data sub-channel not employed for data transfer, and wherein a time period associated with the predetermined number of transmitted (DMT) symbols assigned as a waiting time for execution of the slow system configuration change after the marker associated with the synchronization pattern is substantially larger than a propagation delay of a management channel associated with the management system.

10. The communication system of claim 1, wherein the synchronization flag comprises a fixed pattern that resides within a single transmitted (DMT) symbol or extends over a plurality of transmitted (DMT) symbols.

11. The communication system of claim 10, wherein the synchronization flag further comprises a synchronization pattern violation pattern in conjunction with the fixed pattern, thereby reducing a probability of a false synchronization flag identification based on data that closely resembles the fixed pattern.

12. The communication system of claim 1, wherein the transmission system is further configured to delay the change in system configuration until an acknowledgement of receipt of the synchronization flag from the receiver operably coupled thereto is received at the transmission system.

13. A communication system, comprising a transmission system configured to transmit data to a receiver over a communications medium, and configured to signal an on-line reconfiguration of system configuration parameters to the receiver based upon an identified type of system reconfiguration, and further configured to provide a synchronization flag over a plurality of temporarily assigned data sub-channels for an identified fast reconfiguration condition, and provide a synchronization pattern extending over multiple symbols over one or more dedicated data sub-channels not employed for data transmission or one or more available data sub-channels currently unused for data transmission for an identified slow reconfiguration condition.

14. The communication system of claim 13, wherein the fast reconfiguration condition comprises an increase in a data bit rate transmission.

15. The communication system of claim 13, wherein the slow reconfiguration condition comprises a data bit rate transmission decrease or a change in bit loading based on a change in noise conditions associated with the communication medium or a forward error correction (FEC) parameter change.

16. The communication system of claim 13, wherein the transmission system is further configured to transmit the synchronization flag over a plurality of data sub-channels presently being unused for data transmission, thereby facilitating a fast, robust signaling on a system reconfiguration without an impact on data transmission.

17. The communication system of claim 16, wherein the transmission system is further configured to temporarily select the plurality of presently unused data sub-channels that are presently not being employed for data transfer from a greater number of unused data sub-channels that are presently not being employed for data transfer based on noise condition information associated therewith from the receiver.

18. The communication system of claim 17, wherein the transmission system is further configured to release the temporarily selected data sub-channels from use in synchronization for use as data sub-channels for data transfer after the synchronization flag is transmitted to the receiver, thereby permitting the temporarily selected data sub-channels to be available for data transmission.

19. The communication system of claim 13, wherein the synchronization flag comprises a fixed data pattern that is encoded in one or more symbols.

20. The communication system of claim 19, wherein the fixed data pattern has a large Hamming distance with respect to data being transmitted on the plurality of sub-channels.

21. The communication system of claim 19, wherein the fixed data pattern comprises a synchronization flag pattern and a synchronization flag violation pattern, thereby reducing a probability that the fixed data pattern is mistaken by the receiver as transmitted data.

22. The communication system of claim 19, wherein the fixed data pattern is modulated by a modulation type that differs from a modulation type employed for data modulation.

23. The communication system of claim 13, wherein the synchronization pattern comprises a fixed data pattern that extends over a plurality of symbols, and wherein the transmission system is configured to transmit the fixed data pattern over a plurality of available data sub-channels that have a signal to noise ratio that is below a predetermined level at which such sub-channels are employed for data transmission.

24. The communication system of claim 13, wherein the transmission system is further configured to delay a reconfiguration in the system configuration parameters after transmission of the synchronization flag or synchronization pattern until an acknowledgement is received back from the receiver indicating receipt of the synchronization flag or synchronization pattern, respectively.

25. The communication system of claim 13, wherein the transmission system is further configured to distinguish between a fast system configuration change and a slow system configuration change based on a signal representing a type of system configuration change from the receiver, and wherein upon determination of a slow system configuration change the synchronization pattern extends over a plurality of transmitted symbols.

26. The communication system of claim 25, wherein the synchronization pattern comprises at least two alternating codewords having a large mutual Hamming distance associated therewith.

27. The communication system of claim 26, wherein the at least two alternating codewords are mapped such that a transition between the two codewords always resides between two consequent transmitted (DMT) symbols.

28. The communication system of claim 25, further comprising a management system adapted to define when the change in system configuration is to occur based on a predetermined number of transmitted (DMT) symbols after the synchronization pattern, thereby facilitating a synchronization in the change in system configuration between the transmission system and the receiver operably coupled thereto.

29. The communication system of claim 28, wherein a time period associated with the predetermined number of transmitted (DMT) symbols assigned as a waiting time for execution of the slow system configuration change after a marker associated with the synchronization pattern is substantially larger than a propagation delay of the management channel associated with the management system.

30. A method of performing synchronization for an on-line reconfiguration of system configuration parameters in a communication system, comprising:
identifying a change in an operating condition associated with the communication system;
temporarily assigning a plurality of data sub-channels associated with the communication system that are presently not being employed for data transfer to carry a synchronization flag for transmission to a receiver based on the identified change, wherein the synchronization flag is operable to facilitate a synchronization for the on-line reconfiguration of the system configuration parameters between a transmitter and a receiver; and
transmitting the synchronization flag to the receiver over the plurality of temporarily assigned data sub-channels.

31. The method of claim 30, wherein identifying the change in the operating condition comprises receiving a signal from the receiver indicative of a data bit rate transmission increase or acknowledging a service change command.

32. The method of claim 30, wherein temporarily assigning the plurality of data sub-channels to carry the synchronization flag comprises:
determining which data sub-channels are not currently being employed for data transmission, thereby identifying a set of available data sub-channels;
evaluating the identified set of available data sub-channels; and
generating a subset of data sub-channels for the available sub-channels set available for assignment thereto based on the evaluation.

33. The method of claim 30, wherein identifying the change in an operating condition comprises receiving a signal from the receiver indicative of a data bit rate transmission decrease, a change in bit loading on a plurality of data channels due to a change in noise conditions associated therewith, or a forward error correction (FEC) parameter change, the method further comprising transmitting a synchronization pattern that differs from the synchronization flag over one or more dedicated data sub-channels that are not employed for data transmission or over one or more available data sub-channels not currently employed for data transmission.

34. The method of claim 33, wherein the synchronization pattern comprises a fixed data pattern that is spread over a plurality of transmitted (DMT) symbols.

35. The method of claim 34, wherein the synchronization pattern comprises at least two alternating codewords having a large mutual Hamming distance associated therewith.

36. The method of claim 35, wherein the at least two alternating codewords are mapped such that a transition between the two codewords always resides between two consequent transmitted (DMT) symbols.

37. The method of claim 33, further comprising initiating the change in system configuration parameters a predetermined number of transmitted (DMT) symbols after transmitting the synchronization pattern, thereby facilitating a synchronization in the change in system configuration between the transmission system and the receiver operably coupled thereto.

38. A method of synchronizing an on-line reconfiguration in a communication system, comprising:
identifying an on-line reconfiguration condition comprising one of a fast on-line reconfiguration condition and a slow on-line reconfiguration condition;
temporarily assigning a plurality of presently unused data sub-channels that are presently not being employed for data transfer for transmission of a synchronization flag from a transmitter to a receiver operably coupled thereto in response to identification of the fast on-line reconfiguration; and
transmitting the synchronization flag to the receiver over the temporarily assigned plurality of data sub-channels.

39. The method of claim 38, further comprising releasing the temporarily assigned plurality of data sub-channels after transmitting the first synchronization flag, thereby freeing the plurality of data sub-channels for data transmission thereover.

40. The method of claim 38, wherein temporarily assigning the plurality of presently unused data sub-channels comprises distributing the first synchronization flag over the temporarily assigned plurality of sub-channels, thereby providing a high reliability transmission of the first synchronization flag.

41. The method of claim 38, wherein the synchronization flag comprises a first fixed data pattern comprising a synchronization marker and a second fixed data pattern comprising a synchronization violation marker, thereby reducing a probability that the receiver inadvertently interprets received data as the synchronization flag.

42. The method of claim 38, wherein the synchronization flag is modulated with a different type of modulation than data transmitted over the sub-channels.

43. The method of claim 38, further comprising adjusting configuration parameters for a next symbol after a symbol containing the first synchronization flag.

44. The method of claim 38, further comprising:
assigning a synchronization pattern to a dedicated sub-channel not employed for data transmission or to one or more currently available data sub-channels not presently being employed for data transfer upon an identification of the slow on-line reconfiguration condition; and
transmitting the synchronization pattern to the receiver over the dedicated data sub-channel or the one or more currently available data sub-channels, respectively.

45. The method of claim 44, wherein the synchronization pattern comprises a fixed data pattern that is spread over a plurality of transmitted (DMT) symbols.

46. The method of claim 44, wherein the synchronization pattern comprises at least two alternating codewords having a large mutual Hamming distance associated therewith.

47. The method of claim 46, wherein the at least two alternating codewords are mapped such that a transition between the two codewords always resides between two consequent transmitted (DMT) symbols.

48. The method of claim 44, further comprising initiating the change in system configuration parameters a predetermined number of transmitted (DMT) symbols after transmitting the synchronization pattern, thereby facilitating a synchronization in the change in system configuration between the transmission system and the receiver operably coupled thereto.

49. The method of claim 48, wherein the dedicated sub-channel comprises a data sub-channel, and wherein a time period associated with the predetermined number of transmitted (DMT) symbols assigned as a waiting time for execution of the slow on-line reconfiguration after a marker associated with the synchronization pattern is substantially larger than a propagation delay of a management channel associated with the management system.
